(19) United States
(12) Patent Application Publication
(10) Pub. No.: US 2016/0001952 A1
(43) Pub. Date: Jan. 7, 2016

(54) AN ANTI-COUNTERFEIT PACKAGING

(71) Applicant: BILCARE LIMITED, Pune, Maharashtra (IN)

(72) Inventors: Sanjeev Dattatray KULKARNI, Pune, Maharashtra (IN); Somenath MUKHERJEE, Pune, Maharashtra (IN); Praful NAIK, Pune, Maharashtra (IN); Mohan BHANDARI, Pune, Maharashtra (IN)

(21) Appl. No.: 14/770,665

(22) PCT Filed: Feb. 26, 2014
(86) PCT No.: PCT/IN2014/000126

§ 371 Date: Aug. 26, 2015

(30) Foreign Application Priority Data
Feb. 26, 2013 (IN) 554/MUM/2013

(51) Int. Cl. B65D 79/02; B65D 65/40; B65D 75/36; B32B 37/12; B32B 27/06; B32B 3/00; B32B 38/10; B65D 65/14; B32B 7/12

(52) U.S. Cl. CPC B65D 79/02; B65D 65/14; B65D 65/40; B65D 75/36; B32B 7/12; B32B 27/06; B32B 3/00; B32B 38/10; B32B 37/12; B32B 2255/26; B32B 2255/28; B32B 2255/205; B32B 2553/00; B32B 2309/02; B32B 2309/12; B32B 2309/105

(57) ABSTRACT

The present disclosure provides a multilayer cold-formable film carrying an image which comprises a first layer and a base layer laminated to the first layer and its preparation. The first layer comprises a peelable carrier, a coat of an ester acrylic based primer, a metallized layer, an adhesive coat embossed with an image of a pre-determined pattern. The present disclosure also provides a multi-layer cold-formed anti-counterfeit package.

### CROSS-REFERENCED TO RELATED APPLICATIONS

This application is a National Phase Entry of PCT Patent Application Serial No. PCT/IN2014/000126 filed Feb. 26, 2014, which claims the benefit under 35 USC §119(e) to Indian patent application no. 554/MUM/2013, filed Feb. 26, 2013, the disclosure of each of these applications are expressly incorporated herein by reference in their entireties.

### FIELD OF THE DISCLOSURE

The present disclosure relates to a multilayer formable film. The present disclosure, particularly relates to an anti-counterfeiting multilayer formable film and its preparation.

### BACKGROUND

Counterfeiting causes detrimental health concern for consumers, safety concerns for law enforcement agencies and financial concerns for businesses worldwide. In particular, food and pharmaceutical industries are the most vulnerable to the increasingly sophisticated operations of counterfeiters. Due to widespread product counterfeit issues, branded food and drug companies suffer substantial losses. Currently, troubled economies and companies look to anti-counterfeit technologies as potential saviors.

Anti-counterfeiting technologies currently available can be classified as;

Overt (Visible) technology: This technology enables end user to verify the authenticity of a product. The packaging prepared by using this technology contains optical visible inks which shift the colors as user views the package, hologram, embossing, water marks and the like. They are designed to be applied in such a way that they cannot be reused or removed without being defaced or causing damage to the pack.

Covert (Hidden) technologies: The purpose of a covert technology is to enable the brand owner to identify counterfeited product. The general public will not be aware of its presence nor have the means to verify it. This technology includes use of ultraviolet or infrared light elements on the packaging material which can be recognized only by using sophisticated instruments.

In this regard, hologram and holographic films used on the packaging have offered an important solution. Holograms not only add aesthetic value to a typical packaging, but more importantly, provide an effective anti-counterfeit tool. Furthermore, it provides a simplified means for consumers to deduce the authenticity of a product. Holograms can also be applied on packaging article. The major problem, however, is that they are generally costly and not effective over the long term.

In the embossed imaging technologies, at present two methods are available. One is in which embossed images are transferred to the film used to prepare packaging and another one is where there is direct embedding of embossed images on a film or material used to prepare packaging.

In the conventional transfer technology, the base layer or the packaging film is first coated with an adhesive and a soft coating layer and then a metallization layer (typically aluminium or Zinc Sulphide) is applied on the soft coating layer. An additional layer of heat or pressure sensitive adhesive is applied to the metallized layer. This entire layer forms a transfer layer onto which embossing is transferred with the help of a shim that is made up of nickel. However, this conventional transfer technology leads to poor adhesion as well as micro cracking of the embedded images.

During the cold forming of the aforementioned anti-counterfeit film, any surface that comes in contact with the film has a potential to pick up debris from the packaging and can lead to cut, mark or crack on the film. Furthermore, cold forming of the said anti-counterfeit film may produce inconsistent blisters.

In contrary to the transfer embossing technology, the direct embossing technology does not require any transfer layer. Instead image to be embossed is embedded directly onto the film which can then be used for preparing anti-counterfeit packaging. However, when this technology is used on nylon or soft Aluminum or PVC based films, it causes dents on film or puncturing of the film which in turn affect the barrier properties of packaging prepared from these films.

Accordingly, there is felt a need for a multilayer formable packaging film devoid pin holes or damages and having desired anti-counterfeit properties and its preparation using hitherto unknown transfer technique.

### DEFINITION

The term “cold forming process” as used in the context of the present disclosure means a manufacturing process in which material is shaped at ambient temperature to produce material components with a close tolerance and net shape.

### OBJECT

Some of the objects of the present disclosure, which at least one embodiment herein satisfies, are as follows:

It is an object of the present disclosure to provide a cold formable multilayer film carrying image, which is devoid of pin holes or damages and having desired anti-counterfeit properties.

It is another object of the present disclosure to provide a process for preparing a cold formable multilayer film carrying an image, which is devoid of pin holes or damages and having desired anti-counterfeit properties.

It is still another object of the present disclosure to provide an anti-counterfeit package made from a cold formable multilayer film.

Other objects and advantages of the present disclosure will be more apparent from the following description, which are not intended to limit the scope of the present disclosure.

### SUMMARY

The present disclosure provides a multilayer cold-formable film carrying an image and having a thickness in the range of 100 to 300 micron; said film comprises;
a) a first layer comprising:
   a peelable carrier having a thickness ranging from 10 to 20 micron;
   a coat of an ester acrylic based primer having a thickness ranging from 0.1 to 10 micron on said carrier;
   a metallized layer having a thickness ranging from 0.001 to 0.3 micron deposited on said coat;
   an adhesive coat provided on said metalized layer; and
   an image of a pre-determined pattern embossed on said coat forming an embossed surface; and
b) a base layer having a thickness ranging from 100 to 250 micron laminated to said embossed surface of the first layer.

Typically, said carrier is adapted to be peeled from the film after the lamination of the embossed surface and the base.

Typically, the carrier comprises at least one polyester film, preferably polyethylene terephthalate (PET).

Typically, the base layer comprises at least one polymeric film selected from the group consisting of nylon, nylon 66, polyvinyl chloride (PVC), high density polyethylene (HDPE), low density polyethylene (LDPE), polypropylene (PP), amorphous polyethylene terephthalate (APET), co-polymer of PET with glycol (PETg), Polyethylene (PE), polyester, polyamide, polystyrene, copolymers of polystyrene, poly ethylene vinyl alcohol (EVOH) and combinations thereof.

Typically, the base layer comprises at least two polymeric films in which a metal foil is sandwiched, said metal foil is selected from the group consisting of aluminum foil, gold foil, silver foil, copper foil and platinum foil.

Typically, the base layer comprises aluminum foil of thickness ranging from 20 to 80 micron sandwiched between polyvinyl chloride (PVC) of thickness ranging from 50 to 100 micron and polyamide of thickness ranging from 10 to 30 micron.

Typically, the metalized layer comprises at least one 99% pure metal selected from the group consisting of aluminum, platinum, gold, silver and copper or at least one 99% pure metal compound selected from the group consisting of Zinc oxide, zinc sulfide and silicon oxide.

Typically, the film of the present disclosure is devoid of pin holes or damages.

Typically, the base layer is selected from a group consisting of a transparent base, a translucent base and an opaque base, said base layer is multilayered and one of the layers of the multilayered base is pigmented.

Typically, the film further includes at least one layer selected from the group consisting of a barrier layer, a lacquer layer and an anti-scuffing layer, the barrier layer selected from the group consisting of poly(ethylene vinyl alcohol) (EVOH), polyacrylonitrile, poly(vinylidene dichloride) (PVDC), polyethylene terephthalate (PET), polyethylene napthalate (PEN), polyamide and combinations thereof.

Typically, the pre-determined pattern is selected from the group consisting of graphic patterns and textual patterns, said graphic pattern is at least one selected from a group consisting of a diamond pattern, a broken glass pattern, a rainbow pattern, a dot pattern, a square pattern, a honey comb pattern, a flower pattern, a triangular pattern, a wavy line pattern, a star burst pattern, a circular pattern, a striation pattern and an image pattern.

Typically, the embossable adhesive is selected from the group consisting of polyurethane, acrylic polymer, isocyanides and combinations thereof.

In accordance with the present disclosure there is provided a process for the preparation of a multilayer cold-formable film carrying an image and having a thickness in the range of 100 to 300 micron; said process comprises the following steps:
selecting a peelable carrier having a thickness ranging from 10 to 20 micron, said carrier comprises at least one polyester film, preferably polyethylene terephthalate (PET);
applying a coat of an ester acrylic based adhesive having a thickness ranging from 0.1 to 10 micron on the carrier;
partially drying the coat;
depositing a metallized layer having a thickness ranging from 0.001 to 0.3 micron on the partially dried coat to obtain a metallized carrier, said metallized layer comprises at least one 99% pure metal selected from the group consisting of aluminum, platinum, gold, silver and copper or at least one 99% pure metal compound selected from the group consisting of Zinc oxide, zinc sulfide and silicon oxide;
coating at least one layer of an adhesive coat on the metallized carrier, said adhesive is selected from the group consisting of polyurethane, acrylic polymer, isocyanides and combinations thereof;
embossing an image of a pre-determined pattern on said coat with a shim to form a first layer with an embossed image;
providing a base layer having a thickness ranging from 100 to 250 micron, said base layer is selected from a group consisting of a transparent base, a translucent base and an opaque base, said base layer comprises at least one polymeric film selected from the group consisting of nylon, nylon 66, polyvinyl chloride (PVC), high density polyethylene (HDPE), low density polyethylene (LDPE), polypropylene (PP), amorphous polyethylene terephthalate (APET), co-polymer of PET with glycol (PETg), Polyethylene (PE), polyester, polyamide, polystyrene, copolymers of polystyrene, ethylene vinyl alcohol (EVOH) and combinations thereof;
applying an adhesive layer having a thickness ranging from 1 to 10 micron to the base layer;
laminating the base layer to the embossed surface of the first layer; and
peeling the carrier to obtain a multilayer formable film carrying the image.

The process further comprises a step of heating the base layer in an oven at a temperature ranging from 55 to 80° C. before laminating said base layer to the embossed surface of the first layer.

Typically, the laminating step includes passing the base layer and the first layer through counter rotating rollers at a temperature ranging from 50 to 55° C. and at a pressure ranging from 2 kg/m² to 10 kg/m² and the step of peeling the carrier is carried out after a time period of 30 to 60 hours of lamination.

Typically, the process is capable of producing a multilayered cold-formable film which is devoid of pin holes or damages.

Typically, the process further comprises providing at least one layer selected from the group consisting of a barrier layer, a lacquer layer and an anti-scuffing layer, said barrier layer is selected from the group consisting of poly(ethylene vinyl alcohol) (EVOH), polyacrylonitrile, poly(vinylidene dichloride) (PVDC), polyethylene terephthalate (PET), polyethylene napthalate (PEN), polyamide and combinations thereof, said anti-scuffing layer is selected from a group consisting of silica, molybdenum sulfide, graphite, and iron oxide.

In accordance with another aspect of the present disclosure there is provided multi-layer cold-formed anti-counterfeit package made from the film of the present disclosure, wherein said package is selected from the group consisting of blister package and strip package.

### DETAILED DESCRIPTION

The present disclosure provides a solution for the problems related to the providing an image on the cold formable multi-layer film and its subsequent molding into a package which are typically associated with known image embossing transfer technology.

The present disclosure particularly provides a cold formable multi-layer film having a thickness in the range of 100 to 300 micron which is made up of a first layer and a base layer. The first layer contains a carrier which is peelable.

The peelable carrier exhibits a thickness ranging from 10 to 20 micron and is coated with a coat of an ester acrylic based primer having a thickness ranging from 0.1 to 10 micron upon which a metallized layer having a thickness ranging from 0.001 to 0.3 micron is deposited.

On the metalized layer an adhesive coat is provided which is embossed with an image of a pre-determined pattern forming an embossed surface.

The carrier is at least one polyester film, preferably polyethylene terephthalate (PET). The peelable carrier may be peeled or removed or released from the film after the lamination of the first layer and the base layer.

The metalized layer deposited on ester acrylic based primer contains 99% pure metal selected from the group consisting of aluminum, platinum, gold, silver, copper and combinations thereof. Alternatively, the metalized layer contains 99% pure metal compound selected from the group consisting of Zinc oxide, zinc sulfide, silicon oxide and combinations thereof.

The metallization of the carrier is achieved by improving the adhesion of metal layer or metal compound layer. Improvement in the adhesion of the metal or metal compound layer is achieved by applying a specially developed acrylic based primer coat of thickness 0.1 to 10 micron. Specially developed primer assures the adhesion of the metal or metal compound layer as well as it also helps to improve the stability of the metal or metal compound layer after embossing treatment using a differential grating pattern. This layer also helps to improve display of the embossed pattern. Metals or metal compounds are deposited on the carrier by a vacuum evaporation/deposition technique. Prior to metallic compound coating the carrier may be treated with plasma to achieve better adhesion of the said metal layer.

In accordance with the present disclosure the pre-determined pattern is selected from the group consisting of graphic patterns and textual patterns. The graphic pattern includes but is not limited to a diamond pattern, a broken glass pattern, a rainbow pattern, a dot pattern, a square pattern, a honey comb pattern, a flower pattern, a triangular pattern, a wavy line pattern, a star burst pattern, a circular pattern, a striation pattern and an image pattern.

The base layer to be laminated to the embossed surface of the first layer has a thickness ranging from 100 to 250 micron and is at least one polymeric film selected from the group consisting of nylon, nylon 66, polyvinyl chloride (PVC), high density polyethylene (HDPE), low density polyethylene (LDPE), polypropylene (PP), amorphous polyethylene terephthalate (APET), co-polymer of PET with glycol (PETg), Polyethylene (PE), polyester, polyamide, polystyrene, copolymers of polystyrene, poly ethylene vinyl alcohol (EVOH) and combinations thereof. The base layer can be multilayered and one of the layers of the multilayered base is pigmented.

The base layer is coated with an adhesive selected from the group consisting of polyurethane, acrylic polymer, isocyanides and combinations thereof and then laminated to the embossed surface of the first layer. The coating is carried out by a gravure coating process.

The lamination technique includes but is not limited to a solvent based adhesive lamination, thermal bonding lamination, thermal co-extrusion lamination, inline lamination, dry adhesion lamination, dry lamination and the like.

In one embodiment the lamination is carried out using a dry lamination process which is described herein below.

The prepared base layer (OPA/AL/PVC is unwounded from a un-winder and passed through the tray that contains water based adhesive which is applied to the web. The doctoring process ensures the uniform coating of the adhesive with the help of a doctor blade on OPA side of the base layer (laminate). Gravure roller is designed in such a way that it picks up the required amount of adhesive and deposites over the web. The viscosity of the adhesive is maintained and monitored throughout the process by adjusting the temperature suitably. The deposited adhesive then travels through a specially designed tunnel-type oven with specific temperature zones and to provide a traveling path of approximately 10-12 m. The temperature in the oven is maintained in the range of 70 to 95° C. to dry out the adhesive when it comes out of the tunnel.

The first layer comprising a peelable carrier carrying the embedded image is allowed to come in contact with this web. Then both the layers (films) are passed through nip roller/s whereby the two layers are stuck together under the action of the pressure. The composite layer (film) thus formed is passed over the drum which is equipped with chilled water circulation to help cooling down the laminate (film). The controlled cooling also eliminates the cross linking of adhesive ensuring a good bonding between two layers of the laminate. Releasing layer is then peeled off after 48 hours so that this laminate (film) with the embedded image/s can be used for making cold formed blisters as per desire tablet/capsule size cavity to pack medicine in it.

The base layer of the film of the present disclosure can contain at least two polymeric films in which a metal foil is sandwiched. The metal foil includes but is not limited to aluminum foil, gold foil, silver foil, copper foil and platinum foil.

In one exemplary embodiment the base layer contains aluminum foil of thickness ranging from 20 to 80 micron sandwiched between polyvinyl chloride (PVC) of thickness ranging from 50 to 100 micron and polyamide of thickness ranging from 10 to 30 micron. The aluminum foil used is soft aluminum foil or hard aluminum foil.

The base employed in film of the present disclosure can be selected from a group consisting of a transparent base, a translucent base and an opaque base.

The film of the present disclosure additionally contains layers such as a barrier layer, a lacquer layer, an anti-scuffing layer and combinations thereof.

The barrier layer provides moisture barrier, oxygen barrier, gas barrier and vapor barrier properties. The barrier layer is selected from the group consisting of poly (ethylene vinyl alcohol) (EVOH), polyacrylonitrile, poly(vinylidene dichloride) (PVDC), polyethylene terephthalate (PET), polyethylene napthalate (PEN), polyamide and combinations thereof.

The lacquer layer can be colored or colorless having a thickness of 0.5 to 8 gsm. The anti-scuffing layer contains anti-scuffing material selected from a group consisting of silica, molybdenum sulfide, graphite and iron oxide. In accordance with the present disclosure the thickness of the anti-scuffing layer ranges from 0.1 to 2.0 micron.

In accordance with the present disclosure there is provided a process for the preparation of a multilayer cold-formable film carrying an image and having a thickness in the range of 50 to 500 micron. The process of the present disclosure is capable of producing a multilayered cold-formable film which is devoid of pin holes or damages. The process is described herein below.

Initially, a first layer is prepared which involves the following steps. In the first step, a peelable carrier having a thickness ranging from 10 to 20 micron is selected. To this carrier a coat of an ester acrylic based adhesive having a thickness ranging from 0.1 to 10 micron is applied which is then partially dried. In the next step, a metallized layer having a thickness ranging from 0.001 to 0.3 micron is deposited on the partially dried coat to obtain a metallized carrier. The metalized carrier is further coated with at least one layer of an adhesive coat which is then embossed with an image of a pre-determined pattern with a shim to form a first layer with an embossed surface. The embossed image can be a negative image.

Separately, a base layer having a thickness ranging from 100 to 250 micron is provided. To this base layer an adhesive layer having a thickness ranging from 1 to 10 micron is applied. Then the base layer is laminated to the embossed surface of the first layer. Finally, the carrier is peeled to obtain a multilayer formable film carrying the image.

The process of the present disclosure further includes a step of heating the base layer in an oven at a temperature ranging from 55 to 80° C. before laminating the base layer to the embossed surface of the first layer.

The laminating step may include passing the base layer and the first layer through counter rotating rollers at a temperature ranging from 50 to 55° C. and at a pressure ranging from 2 kg/m² to 10 kg/m² and the step of peeling the carrier is carried out after a time period of 30 to 60 hours of lamination.

One of the rollers used for laminating the base and the carrier is made up of rubber, whereas another roller is made up of metal Additional layers such as a barrier layer, a lacquer layer, an anti-scuffing layer and combinations thereof can also be provided in the film of the present disclosure.

A multilayer formable film prepared by laminating the first layer and the base layer of the present disclosure has improved barrier properties and it is devoid of any pin holes or damages.

The multi-layer formable packaging films according to the present disclosure have excellent bursting strength, barrier properties and deformation resistance. Advantageously, the film according to the present disclosure has high abrasion resistance and also can withstand the cold forming processes without any damage to non-uniform thickness on the embossed design during the process of forming the film in to blisters packaging. An anti-scuffing, anti-abrasive layer can be advantageously provided on the metalized layer. Preferably such a layer may contain silica particles for increasing the anti-scuffing effect. The silica particles may be applied typically, in the form of a lacquer layer.

In accordance with another aspect of the present disclosure there is provided multi-layer cold-formed anti-counterfeit package made from the film of the present disclosure. The package is selected from the group consisting of blister package and strip package.

The anti-counterfeit blister package (container) of the present disclosure consists of a lid element and a base element sealing securely to each other. The base element is made from the multilayer formable film of the present disclosure by molding the film on a blister packing machine by using a cold forming process.

The present disclosure is further described in light of the following examples which are set forth for illustration purpose only and not to be construed for limiting the scope of the disclosure.

### EXAMPLES

### Procedure

A peelable carrier PET film was selected. To this carrier film a coat of an ester acrylic based adhesive was applied which was then partially dried. In the next step, a metallized layer was deposited on the partially dried coat to obtain a metallized carrier. The metalized carrier was further coated with an adhesive coat which was then embossed with an image of a pre-determined pattern with a shim to form a first layer with an embossed surface.

Separately, a base layer was provided. To this base layer an adhesive layer of was applied. The obtained layer was then heated in an oven. Then this base layer was laminated to the embossed surface of the first layer.

The laminating was done by passing the base layer and the first layer through counter rotating rollers. Finally, the carrier was peeled to obtain a multilayer formable film carrying the image.

Additionally, the layers such as lacquer layer, anti-scuffing layer and combinations thereof were applied to the obtained film after peeling off the carrier layer.

### Examples 1-24

The multilayer formable film carrying the image were prepared using particulars provided in the following table and the procedure described herein above.

TABLE 1

| | Thickness | | | | Temp. & | Time to peel |
|---|---|---|---|---|---|---|
| | of the cold | | | Temp. | press. | the carrier |
| Example | formable | | | of | during | after |
| No. | film | First layer | Base layer | oven | lamination | lamination |
| 1 | 143 μm | PET: 12 μm | OPA: 26 μm | 55° C. | 50° C. & | 48 hrs |
| | | Acrylate: 0.5 μm | Al-foil: 45 μm | | 6 kg/m² | |
| | | Al: 0.02 μm | PVC: 66 μm | | | |
| | | Adhesive: 3 μm | Adhesive: 3 μm | | | |
| 2 | 184 μm | PET: 12 μm | OPA: 26 μm | 60° C. | 52° C. & | 48 hrs |
| | | Acrylate: 0.5 μm | Al-foil: 49 μm | | 6 kg/m² | |
| | | Al: 0.02 μm | PVC: 104 μm | | | |
| | | Adhesive: 3 μm | Adhesive: 2.5 μm | | | |
| 3 | 141 μm | PET: 12 μm | OPA: 26 μm | 55° C. | 50° C. & | 40 hrs |
| | | Acrylate: 0.5 μm | Al-foil: 52 μm | | 6 kg/m² | |
| | | Al: 0.02 μm | PVC: 58 μm | | | |
| | | Adhesive: 2 μm | Adhesive: 3 μm | | | |
| 4 | 156 μm | PET: 12 μm | OPA: 24 μm | 70° C. | 53° C. & | 48 hrs |
| | | Acrylate: 0.5 μm | Al-foil: 61 μm | | 6 kg/m² | |
| | | Al: 0.2 μm | PVC: 65 μm | | | |
| | | Adhesive: 3 μm | Adhesive: 3 μm | | | |
| 5 | 145 μm | PET: 12 μm | OPA: 26 μm | 55° C. | 50° C. & | 48 hrs |
| | | Acrylate: 0.5 μm | Al-foll: 47 μm | | 6 kg/m² | |
| | | Al: 0.02 μm | PVC: 64 μm | | | |
| | | Adhesive: 3 μm | Adhesive: 5 μm | | | |
| 6 | 185 μm | PET: 12 μm | OPA: 26 μm | 58° C. | 54° C. & | 55 hrs |
| | | Acrylate: 0.5 μm | Al-foil: 48 μm | | 6 kg/m² | |
| | | Al: 0.02 μm | PVC: 105 μm | | | |
| | | Adhesive: 3 μm | Adhesive: 3 μm | | | |
| 7 | 147 μm | PET: 12 μm | OPA: 26 μm | 55° C. | 55° C. & | 48 hrs |
| | | Acrylate: 0.5 | Al-foil: 51 μm | | 6 kg/m² | |
| | | μmAl: 0.02 μm | PVC: 59 μm | | | |
| | | Adhesive: 3 μm | Adhesive: 8 μm | | | |
| 8 | 160 μm | PET: 12 μm | OPA: 25 μm | 76° C. | 50° C. & | 48 hrs |
| | | Acrylate: 1 μm | Al-foil: 63 μm | | 6 kg/m² | |
| | | Al: 0.02 μm | PVC: 62 μm | | | |
| | | Adhesive: 4 μm | Adhesive: 3 μm | | | |
| 9 | 135 μm | PET: 12 μm | OPA: 25 μm | 55° C. | 52° C. & | 48 hrs |
| | | Acrylate: 0.5 μm | Al-foil: 43 μm | | 6 kg/m² | |
| | | Al: 0.1 μm | PVC: 58 μm | | | |
| | | Adhesive: 5 μm | Adhesive: 4 μm | | | |
| 10 | 181 μm | PET: 12 μm | OPA: 28 μm | 55° C. | 54° C. & | 30 hrs |
| | | Acrylate: 1.5 μm | Al-foil: 48 μm | | 6 kg/m² | |
| | | Al: 0.05 μm | PVC: 98 μm | | | |
| | | Adhesive: 4 μm | Adhesive: 3 μm | | | |
| 11 | 143 μm | PET: 12 μm | OPA: 27 μm | 80° C. | 50° C. & | 48 hrs |
| | | Acrylate: 0.5 μm | Al-foil: 52 μm | | 6 kg/m² | |
| | | Al: 0.02 μm | PVC: 58 μm | | | |
| | | Adhesive: 3 μm | Adhesive: 3 μm | | | |
| 12 | 150 μm | PET: 12 μm | OPA: 24 μm | 55° C. | 52° C. & | 60 hrs |
| | | Acrylate: 0.5 μm | Al-foil: 60 μm | | 6 kg/m² | |
| | | Al: 0.02 μm | PVC: 60 μm | | | |
| | | Adhesive: 3 μm | Adhesive: 3 μm | | | |
| 13 | 135 μm | PET: 12 μm | OPA: 24 μm | 64° C. | 50° C. & | 48 hrs |
| | | Acrylate: 4 μm | Al-foil: 44 μm | | 6 kg/m² | |
| | | Al: 0.02 μm | PVC: 59 μm | | | |
| | | Adhesive: 3 μm | Adhesive: 3 μm | | | |
| 14 | 175 μm | PET: 12 μm | OPA: 24 μm | 55° C. | 54° C. & | 48 hrs |
| | | Acrylate: 0.5 μm | Al-foil: 47 μm | | 6 kg/m² | |
| | | Al: 0.02 μm | PVC: 96 μm | | | |
| | | Adhesive: 3 μm | Adhesive: 5 μm | | | |
| 15 | 142 μm | PET: 12 μm | OPA: 26 μm | 68° C. | 53° C. & | 48 hrs |
| | | Acrylate: 0.5 μm | Al-foil: 51 μm | | 6 kg/m² | |
| | | Al: 0.02 μm | PVC: 59 μm | | | |
| | | Adhesive: 3 μm | Adhesive: 3 μm | | | |
| 16 | 148 μm | PET: 12 μm | OPA: 23 μm | 60° C. | 50° C. & | 48 hrs |
| | | Acrylate: 0.5 μm | Al-foil: 57 μm | | 6 kg/m² | |
| | | Al: 0.02 μm | PVC: 62 μm | | | |
| | | Adhesive: 3 μm | Adhesive: 3 μm | | | |
| 17 | 142 μm | PET: 12 μm | OPA: 26 μm | 55° C. | 55° C. & | 48 hrs |
| | | Acrylate: 0.5 μm | Al-foil: 48 μm | | 6 kg/m² | |
| | | Al: 0.02 μm | PVC: 62 μm | | | |
| | | Adhesive: 3 μm | Adhesive: 3 μm | | | |
| 18 | 183 μm | PET: 12 μm | OPA: 26 μm | 55° C. | 53° C. & | 48 hrs |
| | | Acrylate: 0.5 μm | Al-foil: 48 μm | | 6 kg/m² | |
| | | Al: 0.02 μm | PVC: 103 μm | | | |
| | | Adhesive: 3 μm | Adhesive: 3 μm | | | |
| 19 | 146 μm | PET: 12 μm | OPA: 25 μm | 60° C. | 50° C. & | 48 hrs |
| | | Acrylate: 1 μm | Al-foil: 53 μm | | 6 kg/m² | |
| | | Al: 0.1 μm | PVC: 62 μm | | | |
| | | Adhesive: 3 μm | Adhesive: 3 μm | | | |
| 20 | 150 μm | PET: 12 μm | OPA: 24 μm | 55° C. | 52° C. & | 48 hrs |
| | | Acrylate: 2 μm | Al-foil: 59 μm | | 6 kg/m² | |
| | | Al: 0.05 μm | PVC: 60 μm | | | |
| | | Adhesive: 4 μm | Adhesive: 3 μm | | | |
| 21 | 144 μm | PET: 12 μm | OPA: 27 μm | 55° C. | 50° C. & | 48 hrs |
| | | Acrylate: 0.5 μm | Al-foil: 49 μm | | 6 kg/m² | |
| | | Al: 0.2 μm | PVC: 61 μm | | | |
| | | Adhesive: 3.5 μm | Adhesive: 3 μm | | | |
| 22 | 178 μm | PET: 12 μm | OPA: 24 μm | 58° C. | 52° C. & | 48 hrs |
| | | Acrylate: 0.5 μm | Al-foil: 46 μm | | 6 kg/m² | |
| | | Al: 0.02 μm | PVC: 101 μm | | | |
| | | Adhesive: 3 μm | Adhesive: 3 μm | | | |
| | | Silica (as anti-scuffing): 1 μm | | | | |
| 23 | 138 μm | PET: 12 μm | OPA: 24 μm | 55° C. | 54° C. & | 48 hrs |
| | | Acrylate: 0.5 μm | Al-foil: 48 μm | | 6 kg/m² | |
| | | Al: 0.02 μm | PVC: 59 μm | | | |
| | | Adhesive: 3 μm | Adhesive: 3 μm | | | |
| | | Red lacquer: 1 μm | | | | |
| 24 | 150 μm | PET: 12 μm | OPA: 25 μm | 55° C. | 50° C. & | 48 hrs |
| | | Acrylate: 0.5 μm | Al-foil: 58 μm | | 6 kg/m² | |
| | | Al: 0.02 μm | PVC: 59 μm | | | |
| | | Adhesive: 3 μm | Adhesive: 3 μm | | | |

Silica (as anti-scuffing): 1 μm
Red lacquer: 1 μm

*PET: polyethylene terephthalate, OPA: polyamide, Al: aluminium, PVC: polyvinyl chloride

The obtained films were subjected to checking the pinholes or any other damages. It was found that none of the films prepared in accordance with the present disclosure exhibits pinholes or damages.

### Example 25

### Preparation of Blister Package by Cold Forming Process

The film as described in the example 1 was used for preparing a base element of the blister pack. The obtained film was passed through a blister packing machine wherein the cavities were formed in the film, product intended to be packaged in the cavity was filled in the cavity and lidding material was sealed to the base element. The embodiments herein and the various features and advantageous details thereof are explained with reference to the non-limiting embodiments in the description. Descriptions of well-known components and processing techniques are omitted so as to not unnecessarily obscure the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

1. A multilayer cold-formable film carrying an image and having a thickness in the range of 100 to 300 micron; said film comprises;
a) a first layer comprising:
i. a peelable carrier having a thickness ranging from 10 to 20 micron;
ii. a coat of an ester acrylic based primer having a thickness ranging from 0.1 to 10 micron on said carrier;
iii. a metallized layer having a thickness ranging from 0.001 to 0.3 micron deposited on said coat;
iv. an adhesive coat provided on said metalized layer; and
v. an image of a pre-determined pattern embossed on said coat forming an embossed surface, and
b) a base layer having a thickness ranging from 100 to 250 micron laminated to said embossed surface of the first layer.

2. The film as claimed in claim 1, wherein said carrier is adapted to be removed from the film after the lamination of the embossed surface of the first layer and the base layer.

3. The film as claimed in claim 1, wherein the carrier comprises at least one polyester film, preferably polyethylene terephthalate (PET).

4. The film as claimed in claim 1, wherein the base layer comprises at least one polymeric film selected from the group consisting of nylon, nylon 66, polyvinyl chloride (PVC), high density polyethylene (HDPE), low density polyethylene (LDPE), polypropylene (PP), amorphous polyethylene terephthalate (APET), co-polymer of PET with glycol (PETg), Polyethylene (PE), polyester, polyamide, polystyrene, copolymers of polystyrene, poly ethylene vinyl alcohol (EVOH) and combinations thereof.

5. The film as claimed in claim 1, wherein the base layer comprises at least two polymeric films in which a metal foil is sandwiched, said metal foil is selected from the group consisting of aluminum foil, gold foil, silver foil, copper foil and platinum foil.

6. The film as claimed in claim 1, wherein the base layer comprises aluminum foil of thickness ranging from 20 to 80 micron sandwiched between polyvinyl chloride (PVC) of thickness ranging from 50 to 100 micron and polyamide of thickness ranging from 10 to 30 micron.

7. The film as claimed in claim 1, wherein the metalized layer comprises at least one 99% pure metal selected from the group consisting of aluminum, platinum, gold, silver and copper or at least one 99% pure metal compound selected from the group consisting of Zinc oxide, zinc sulfide and silicon oxide.

8. The film as claimed in claim 1, characterized in that said film is devoid of pin holes or damages.

9. The film as claimed in claim 1, wherein the base layer is selected from a group consisting of a transparent base, a translucent base and an opaque base, said base layer is multilayered and one of the layers of the multilayered base is pigmented.

10. The film as claimed in claim 1, further includes at least one layer selected from the group consisting of a barrier layer, a lacquer layer and an anti-scuffing layer, the barrier layer selected from the group consisting of poly(ethylene vinyl alcohol) (EVOH), polyacrylonitrile, poly(vinylidene dichloride) (PVDC), polyethylene terephthalate (PET), polyethylene napthalate (PEN), polyamide and combinations thereof.

11. The film as claimed in claim 1, wherein the pre-determined pattern is selected from the group consisting of graphic patterns and textual patterns, said graphic pattern is at least one selected from a group consisting of a diamond pattern, a broken glass pattern, a rainbow pattern, a dot pattern, a square pattern, a honey comb pattern, a flower pattern, a triangular pattern, a wavy line pattern, a star burst pattern, a circular pattern, a striation pattern and an image pattern.

12. The film as claimed in claim 1, wherein the adhesive is selected from the group consisting of polyurethane, acrylic polymer, isocyanides and combinations thereof.

13. A process for the preparation of a multilayer cold-formable film carrying an image and having a thickness in the range of 100 to 300 micron; said process comprises the following steps:
selecting a peelable carrier having a thickness ranging from 10 to 20 micron, said carrier comprises at least one polyester film, preferably, polyethylene terephthalate (PET);
applying a coat of an ester acrylic based adhesive having a thickness ranging from 0.1 to 10 micron on the carrier;
partially drying the coat;
depositing a metallized layer having a thickness ranging from 0.001 to 0.3 micron on the partially dried coat to obtain a metallized carrier, said metallized layer comprises at least one 99% pure metal selected from the group consisting of aluminum, platinum, gold, silver and copper or at least one 99% pure metal compound selected from the group consisting of Zinc oxide, zinc sulfide and silicon oxide;
coating at least one layer of an adhesive coat on the metallized carrier, said adhesive is selected from the group consisting of polyurethane, acrylic polymer, isocyanides and combinations thereof;
embossing an image of a pre-determined pattern on said coat with a shim to form a first layer with an embossed surface;
providing a base layer having a thickness ranging from 100 to 250 micron, said base layer is selected from a group consisting of a transparent base, a translucent base and an opaque base, said base layer comprises at least one polymeric film selected from the group consisting of nylon, nylon 66, polyvinyl chloride (PVC), high density polyethylene (HDPE), low density polyethylene (LDPE), polypropylene (PP), amorphous polyethylene terephthalate (APET), co-polymer of PET with glycol (PETg), Polyethylene (PE), polyester, polyamide, polystyrene, copolymers of polystyrene, ethylene vinyl alcohol (EVOH) and combinations thereof;
applying an adhesive layer having a thickness ranging from 1 to 10 micron to the base layer;
laminating the base layer to the embossed surface of the first layer; and
peeling the carrier to obtain a multilayer formable film carrying the image.

14. The process as claimed in claim 13, further comprises a step of heating the base layer in an oven at a temperature ranging from 55 to 80° C. before laminating said base layer to the embossed surface of the first layer.

15. The process as claimed in claim 13, wherein the laminating step includes passing the base layer and the first layer through counter rotating rollers at a temperature ranging from 50 to 55° C. and at a pressure ranging from 2 kg/m² to 10 kg/m² and the step of peeling the carrier is carried out after a time period of 30 to 60 hours of lamination.

16. The process as claimed in claim 13, wherein the base layer comprises at least two polymeric films in which a metal foil is sandwiched, said metal foil is selected from the group consisting of aluminum foil, gold foil, silver foil, copper foil and platinum foil.

17. The process as claimed in claim 13, wherein the base layer comprises aluminum foil of thickness ranging from 20 to 80 micron sandwiched between polyvinyl chloride (PVC) of thickness ranging from 50 to 100 micron and polyamide of thickness ranging from 10 to 30 micron.

18. The process as claimed in claim 13, characterized in that said process is capable of producing a multilayered cold-formable film which is devoid of pin holes or damages.

19. The process as claimed in claim 13, further comprises providing at least one layer selected from the group consisting of a barrier layer, a lacquer layer and an anti-scuffing layer, said barrier layer is selected from the group consisting of poly(ethylene vinyl alcohol) (EVOH), polyacrylonitrile, poly(vinylidene dichloride) (PVDC), polyethylene terephthalate (PET), polyethylene napthalate (PEN), polyamide and combinations thereof, said anti-scuffing layer is selected from a group consisting of silica, molybdenum sulfide, graphite, and iron oxide.

20. A multi-layer cold-formed anti-counterfeit package made from the film as claimed in claim 1, wherein said package is selected from the group consisting of blister package and strip package.
